(19) United States
(12) Patent Application Publication
(10) Pub. No.: US 2004/0191039 A1
(43) Pub. Date: Sep. 30, 2004

(54) Device for loading material into hauling vehicles

(76) Inventor: Paul H. Lundeen, Monument, CO (US)

Correspondence Address: Holme Roberts & Owen, LLP, Suite 1300, 90 South Cascade Avenue, Colorado Springs, CO, 80903, US

(21) Appl. No.: 10/731,514

(22) Filed: Dec. 9, 2003

Related U.S. Application Data
(60) Provisional application No. 60/432,824, filed on Dec. 12, 2002.

(51) Int. Cl. B60P 1/64

(52) U.S. Cl. 414/500

(57) ABSTRACT

An apparatus for collection and loading of material into hauling vehicles, such as rear-loading trucks. The apparatus includes a receiving member, preferably formed in the shape of a platform or tray, that is attached to the vehicle by a connector proximate its storage area. The connector allows the receiving member to be rotated from a deployed position, in which material is loaded on to the receiving member, towards a generally upright transfer position, in which the material is transferred to the storage area of the vehicle. The apparatus includes an operation means, which is activated to raise and lower the receiving member.

### CROSS-REFERENCE TO RELATED APPLICATION

This is a non-provisional application which claims priority from provisional application serial No. 60/432,824 filed Dec. 12, 2002 by inventor Paul H. Lundeen, and this application is incorporated herein by reference.

### BACKGROUND

1. Field

The apparatus is directed generally to collection and loading of material into hauling vehicles and more particularly to an improved system for lifting and loading material into rear-loading trucks.

2. Related Art

A common method for collecting and hauling materials involves hauling vehicles, such as rear-loading trucks. Such trucks typically have a container for storing material and a tailgate section, including a bin, through which material is loaded, and then swept mechanically into the container. Operators often load material into trucks by shoveling it into the tailgate section, or by dumping the contents of cans or other containers into the bin of the tailgate section.

In the landscaping field, a common practice is to gather clippings, leaves, and other yard and garden debris into an area and then manually-transfer the debris into the vehicle. As will be appreciated, lifting or shoveling material from the ground level, or from an open-topped wheelbarrow or container, upwards into the vehicle, involves considerable physical exertion.

Various methods have been developed for lifting containers of garbage and debris and dumping them into top loading or rear loading trucks. Examples are Zelinka, U.S. Pat. Nos. 5,257,877 and 5,069,593, and Teske, U.S. Pat. No. 4,676,431. The lifting apparatus of these methods is primarily concerned with connecting to and lifting a container, which is independent of the truck. Various belt, drum and scoop loading systems for loading leaves on city streets into a truck are described in Wymore, U.S. Pat. No. 5,339,613. These devices, like leaf blower devices, are usually limited in their capacity to load large bulky materials, like tree branches and limbs, uprooted shrubs, fencing, and the like.

In a further area of vehicle loading, various platform lifts and gates have been developed, to elevate an object or load upwards to the level of a truck bed. These systems ordinarily do not include the function of moving the object or load onto the truck bed. Examples are Agtuca, U.S. Pat. No. 5,478,189 and Zrostlik, U.S. Pat. No. 4,787,809.

### SUMMARY

An apparatus for loading material into a hauling vehicle is described. The apparatus includes a receiving member for receiving material thereon and transferring the material to a storage area of the hauling vehicle. The receiving member includes a vehicle end positioned towards the hauling vehicle, and a loading end, and includes a connector, such as a hinge or pivot pin arrangement, that connects the vehicle end of the receiving member to the hauling vehicle. The connector rotatably connects the receiving member to the hauling vehicle, such that the receiving member can be rotated or tilted upwards from a deployed position, in which material is deposited on the loading end of the receiving member, to a transfer position, wherein the material falls or slides into the storage area of the hauling vehicle. The apparatus further includes an operation means for moving the receiving member from a deployed position to a transfer position, and thence to a storage position when the vehicle is transported. The operation means is any mechanism capable of moving the receiving member up and down from deployed to transfer positions, such as a reel and cable, hydraulic, or worm gear mechanism.

In a preferred embodiment, the loading end of the receiving member includes a base member formed in the shape of a platform or tray, extending away from the vehicle, with sidewalls extending upwards from the base member, and includes also a vehicle end, which is also in the shape of a platform or tray. In this embodiment, the vehicle end is joined to and is configured at an angle relative to the base member in the range of about 120° to about 160° . The vehicle end, which is connected to the vehicle, also has attached to it a guide member that extends into or above the storage area of the vehicle, and serves to guide material towards the storage area when the receiving member is placed into a transfer position. In operation, the apparatus is placed in a selected deployed position, and material is deposited on the base member of the receiving member. The operation means is activated, rotating the receiving member upwards to a transfer position in which material slides or falls along the vehicle end and guide member into the storage area of the hauling vehicle. The receiving member is then lowered back to a deployed position, to receive more material. The operation means is a reel and cable mechanism. In another embodiment, it is a hydraulic ram mechanism.

### DESCRIPTION OF THE DRAWINGS

FIG. 1 is a perspective view of the apparatus attached to a hauling vehicle, and aligned in a deployed position.

FIG. 2 is a side view of the apparatus of FIG. 1, in a deployed position.

FIG. 3 is a side view of the apparatus of FIG. 1, in a transfer position.

FIG. 4 is an enlarged perspective view of the apparatus as seen from the loading end of the receiving member of the apparatus.

FIG. 5 is a side view of the apparatus of FIG. 1, in a storage position.

FIG. 6 is a side view of another embodiment of the apparatus, in a deployed position, attached to another type of hauling vehicle.

FIG. 7 is a side view of the embodiment of FIG. 5, showing the apparatus in a transfer position.

FIG. 8 is a side view of another embodiment of the apparatus in deployed position, including a hydraulic ram.

FIG. 9 is a side view of the embodiment of FIG. 8, in a transfer position.

### DETAILED DESCRIPTION

An apparatus for loading material into a hauling vehicle is described. In a preferred embodiment, the apparatus is attached to the hauling vehicle, and is transported with the vehicle to the work site. The apparatus is advantageously used with rear-loading hauling vehicles, although those familiar with the field will understand that it can also be implemented with open, top-loading vehicles, and with side-loading hauling vehicles. The apparatus can also be implemented to transfer material to flatbed trailer and other trailer arrangements.

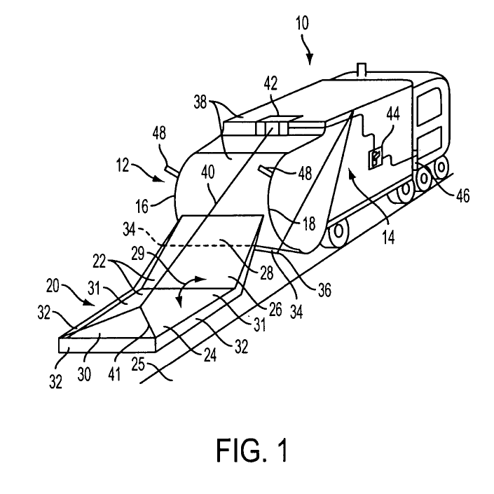

A preferred embodiment of the apparatus is depicted in FIG. 1. The apparatus 20 is depicted in the context of a hauling vehicle 10, having a tailgate section 12 and a container 14. The tailgate section 12 includes a receptacle 16 into which material, such as garbage or yard debris, is deposited. A receptacle opening 18, provides access for deposit of material into the receptacle 16. The hauling vehicle 10 depicted in FIG. 1 is of the type wherein material deposited in the receptacle 16 is periodically swept mechanically into the interior of the container 14, where it is stored and mechanically compacted. The hauling vehicle 10 is emptied by a process in which the tailgate section 12 is lifted, and the contents of the container 14 are ejected out of the rear of the hauling vehicle 10. In the present embodiment, the receptacle 16 and container 14 together constitute the storage area of the hauling vehicle 10, although in other vehicles the storage area, where material to be hauled is loaded and held, is a single compartment or area of the vehicle.

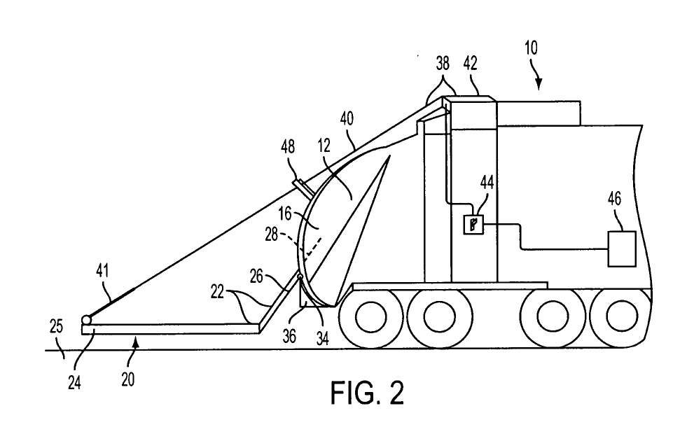

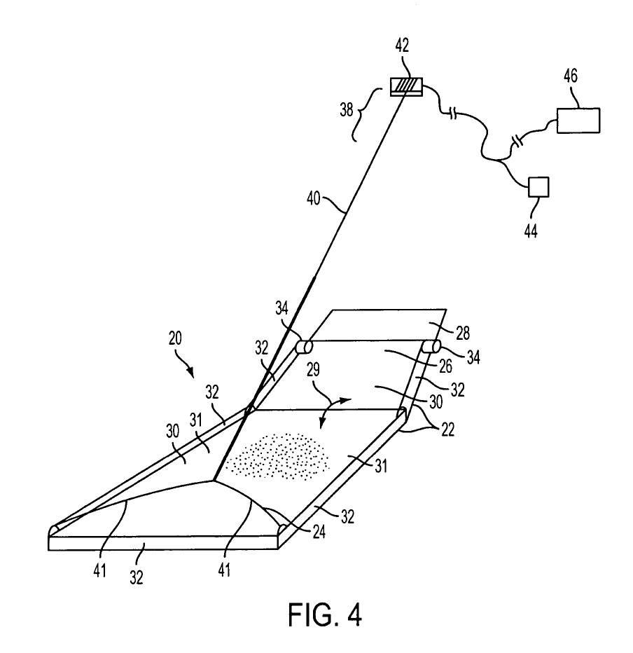

As depicted in FIGS. 1 and 4, the apparatus 20 includes a receiving member 22, which has a loading end 24 and a vehicle end 26. In the present embodiment, the vehicle end 26 includes a guide member 28, which extends towards the receptacle 16 of the tailgate section 12 of the vehicle 10, although a guide member can be omitted from the apparatus. The guide member 28 helps to assure that debris on the receiving member 22 will travel into the receptacle 16 during unloading, and not fall off the receiving member 22. In the present embodiment, a side view of which is also depicted in FIG. 2, the receiving member 22 has an angled shape, which permits the loading end 24 to be positioned close to the ground surface 25. This angled shape reduces the distance a user is required to lift objects from the ground surface 25 to load them onto the receiving member 22. In another embodiment, the receiving member 22 is completely flat and has no angled shape. As will be appreciated, if the receptacle opening 18, which receives material unloaded from the receiving member is attached, is close to the ground surface 25, the need for an angled shape, to bring the loading end 24 of the receiving member 22 close to the ground surface 25, is obviated. Also, in some applications, there may be less need for placing the loading end 24 close to the ground surface 25, such as where the user is loading material from a loading dock or is depositing material on the loading end 24 from an otherwise elevated position.

Referring to FIG. 1, the loading end 24 of the receiving member 22 includes a base member 30 formed of a flat metal piece, formed in the shape of a tray, although in other embodiments it can be formed from a sheet of molded plastic, or composite materials, or wood. In one application, the base member 30 of the receiving member 22 is a wooden frame to which a nylon, treated canvas or Kevlar plastic sheet is clipped to support garden debris or other material loaded on the receiving member 22. In another application, the base member 30 includes a metal frame, with plastic sheeting stretched across the framework to receive material to be loaded in the hauling vehicle 10. In a further application, the base member 30 includes plastic frame members, with a thin sheet or platform attached to the frame members to form a tray for support of material loaded on the receiving member. In the present embodiment, the base member 30 is flat, although in other embodiments it may be formed in a dish or scooped shape, or contoured or grooved, to enhance the movement of material down the receiving member 22 during unloading.

Referring to FIGS. 1 and 4, in the present embodiment, the vehicle end 26 of the receiving member 22 is configured at an angle 29 of about 145 degrees relative to the base member 30 including its loading end 24, although it is contemplated that the angle may be greater or lesser, in the range of about 90° to about 180° , depending on the structure of the vehicle and the user's needs. In a preferred arrangement, the receiving member 22 is configured in an angled shape such that the angle 29 between the vehicle end 26 and the base member 30 is in the range of about 120 degrees to about 160 degrees.

In the present embodiment, as depicted in FIGS. 1 and 4, the receiving member 22 includes opposite sides 31, and side walls 32 which extend upward from the opposite sides 31 to prevent material from falling off the base member 30, and help guide such material towards the receptacle 16 during unloading. These side walls 32 are formed of thin metal in the present embodiment, although in other embodiments they may be formed of plastic, rubber, wood, or other material formed in thin sheets and having sufficient strength and rigidity to serve as retaining walls for materials placed on the platform. In the present embodiment, the side walls 32 are in the range of 3 to 6 inches in height, although in other embodiments, side walls 32 of a different height could be substituted. Additionally, in the present embodiment, the side walls 32 extend around the loading end 24 and are on opposite sides of the vehicle end 26, although they do not extend to the guide member 28. In other embodiments, it is contemplated that the receiving member 22 does not include side walls or other retaining walls, or alternatively that the receiving member only has side walls in limited areas, such as on the opposite sides of the loading end 24 and the vehicle end 26, or on the guide member 28. The description of the present embodiment is not intended to limit the configuration or size of side wall arrangements in the apparatus, or to suggest that they are present in all embodiments of the apparatus. In a further embodiment, one or more pads or bumpers can be affixed to the under side of the loading end 24, to protect the loading end 24 from damage from repeated contact with the ground or road surface, and also to protect the ground or road surfaces from damage. These pads or bumpers are formed of rubber, plastic or any other material suitable for such purposes.

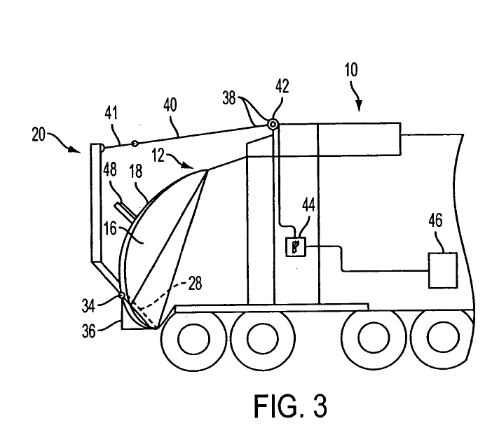

As depicted in FIGS. 1, 2, 3, and 5 the apparatus 20 also includes a connector 34 for attaching the receiving member 22 to the hauling vehicle 10. The connector 34 is located on the vehicle end 26 of the receiving member 22, and includes a mechanism, such as a pivot or hinge, which allows the receiving member 22 to rotate around an axis that runs along a rear support member 36 positioned proximate the lower edge of the receptacle 16. The receiving member 22 accordingly can be raised up from a deployed position, as depicted in FIG. 2, in which the receiving member 22 is nearly horizontal and the loading end 24 of the receiving member 22 extends away from the back of the hauling vehicle 10, which facilitates loading, to a transfer position, as depicted in FIG. 3, in which the receiving member 22 is in a nearly vertical position relative to the tailgate section 12 of the vehicle 10. In alternative embodiments, it is contemplated that the user can lower the receiving member 22 to a selected deployed position. This may be a slightly elevated position, or a position close to or touching the ground as desired by the user. It is also contemplated that the user can raise the receiving member 22 to a selected transfer position, at which the material on the receiving member 22 falls or slides into the receptacle 16. Depending on the nature and quantity of material to be transferred, the transfer position may involve rotating the receiving member 22 to a more or less vertically aligned position relative to the rear of the hauling vehicle 10.

The apparatus 20 includes an operation means 38 for raising and lowering the receiving member 22, to transfer material deposited on the receiving member 22 into the receptacle 16 of the tailgate section 12. In the present embodiment, the operation means 38 includes a reel and cable mechanism, whereby a cable 40 is attached on one end to the loading end 24 of the receiving member 22 and on the other end to a motorized reel 42 located on the vehicle 10. In the present embodiment, as depicted in FIG. 1 the cable 40 is attached to a bridle 41 by which it is attached to the loading end 24. In an alternative embodiment, a snap ring or locking ring or other similar mechanism may be used at the point where the cable 40 attaches to the bridle 41, so that the cable 40 can be unclipped, and pulled to one side, such as when the receiving member 22 is being loaded with debris. When the operation means 38 is activated, a portion of the cable 40 is wound up on the motorized reel 42, thereby pulling the loading end 24 of the receiving member 22 upwards towards a nearly vertically aligned transfer position, and causing material on the receiving member 22 to slide or fall with the force of gravity downwards into the receptacle 16. Once the material is transferred from the receiving member 22 into the receptacle 16, the operation means 38 is activated to unwind the cable 40 from the motorized reel 42, and to lower the loading end 24 of the receiving member 22 back to a desired deployed position. As depicted in FIGS. 2 and 3, the operation means 38 includes an activation means 44, located in a position accessible to a user, such as a three-way switch (wind, unwind, stop) on the side of the hauling vehicle 10, and a power source 46, which provides power to operate the motorized reel 42. Other means for raising and lowering the receiving member 22 can be substituted, such as a hydraulic mechanism, chain drive or gear mechanisms, including worm gear mechanisms, or motor driven arms or rods. The description of the present embodiment is not intended to limit the mechanisms that may be used for lifting and lowering the receiving member 22 from a deployed position to a transfer position.

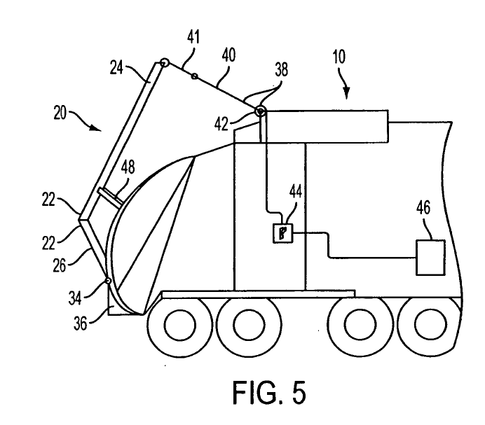

In a further embodiment of the apparatus 20, the receiving member 22 may be positioned in a storage position, whereby the receiving member 22 is positioned in its most upright position, such as for travel from one site to another. As depicted in FIGS. 1, 2, 3, and 5, storage arms 48 can be included on the hauling vehicle 10, which may be used for securing the receiving member 22 during travel. FIG. 5 is a side view of the vehicle 10 and apparatus 20, which depicts the receiving member 22 in a storage position, secured against the storage arms 48. In alternative embodiments, it is contemplated that the receiving member 22 can be rotated toward the vehicle 10 such that, in its storage position, it is in contact or nearly in contact with the rear or top of the vehicle.

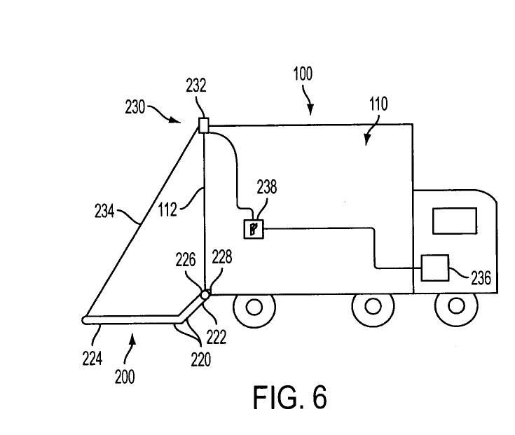

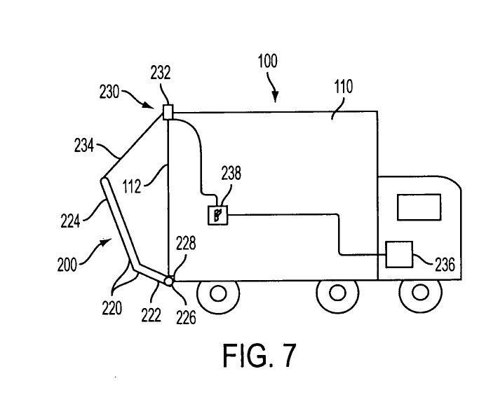

FIG. 6 depicts another embodiment of the apparatus 200 in which it is attached to a hauling vehicle 100 with a closed top storage area 110, and simple rear-loading arrangement, consisting of a sliding door 112 (not visible) that is opened to permit loading of the storage area 110 from the rear of the vehicle 100. The apparatus 200 includes a receiving member 220, including a vehicle end 222 and loading end 224, which are depicted in an angled configuration, although other configurations may be utilized, as discussed previously in connection with another embodiment of the apparatus. The receiving member 220 is attached to the vehicle 100 at the vehicle end 222 proximate the storage area 110, by a connector 226, positioned on the vehicle end 222, and also attached to a rear support member 228 of the vehicle 100. The rear support member 228 may be positioned in any location that serves the efficient transfer of material into the vehicle, and it is envisioned that, in alternative embodiments, the rear support member 228 may be elevated to facilitate the placement of material in a desired location in the storage area 110. The apparatus 200 also includes an operation means 230 for moving the receiving member 220 from a deployed position, selected by the user, in which the user deposits material on the receiving member 220, to a transfer position, in which the material slides or falls from the receiving member 220 into the storage area 110 of the vehicle 100. FIG. 6 depicts the apparatus in a deployed position. FIG. 7 depicts the apparatus of FIG. 6 in a transfer position. As depicted in FIGS. 6 and 7, the operation means 230 includes a reel and cable mechanism, including a motorized reel 232 attached to said vehicle 100 and a cable 234 extending from said motorized reel 232 to said receiving member 220. Said operation means 230 also includes a power source 236, for powering the motorized reel 232, and an activation means 238, for activating the motorized reel 232 to wind and unwind the cable 234, thereby causing the receiving member 220 to be raised and lowered between deployed and transfer positions. Other types of operation means can be substituted for the reel and cable arrangement, including hydraulic mechanisms, chain drive or worm gear mechanisms, and motor driven arms or rods, and the present description is not intended to limit the apparatus to the mechanisms depicted. In other embodiments, the apparatus 200 can be attached to other kinds of hauling vehicles, such as pick-up trucks and related vehicles, and flat-bed trailer and other hauling trailer arrangements, and applied to transfer material into the storage areas of such vehicles, such as the bed of a pickup truck and the flatbed platform of a flatbed trailer.

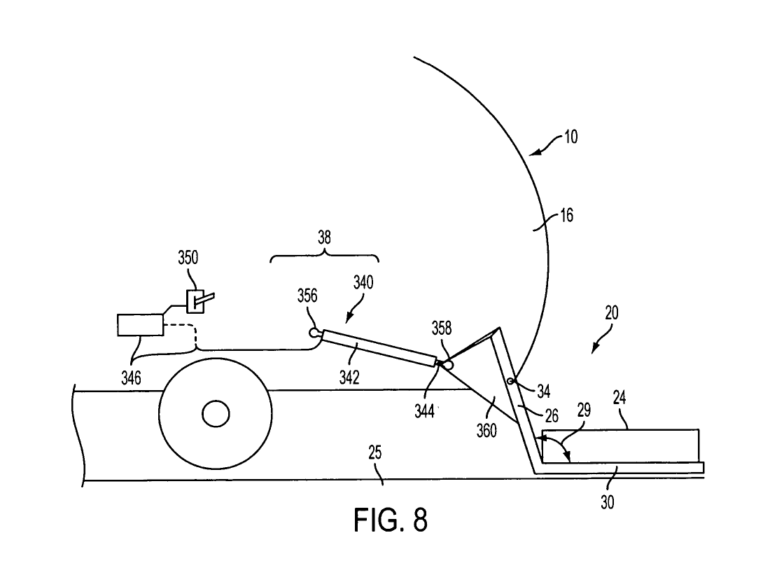

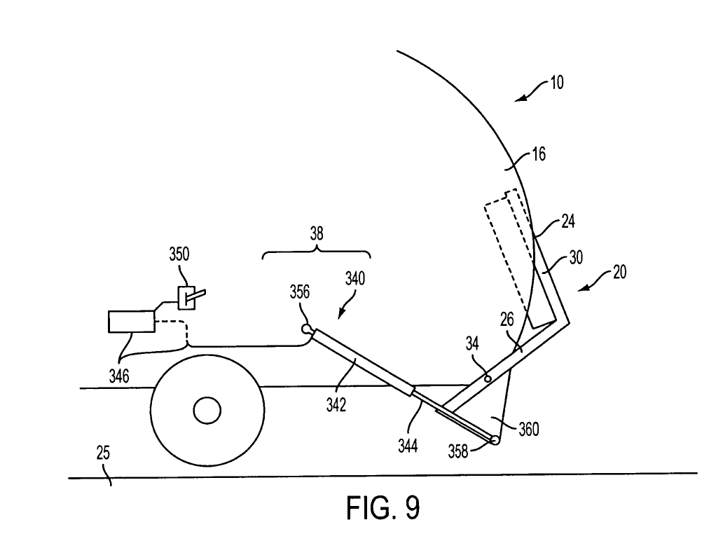

The embodiment depicted in FIG. 8 includes an operation means 38 with a hydraulic mechanism. FIG. 8 is a side view of a hauling vehicle 10 and an apparatus 20 similar to those depicted in FIGS. 1 and 2. In FIG. 8, the apparatus 20, however, has a hydraulic ram mechanism for lifting the receiving member 22 from a deployed position to a transfer position, instead of the reel and cable mechanism depicted in FIGS. 1 and 2. The hydraulic ram mechanism includes, on each side of the truck, a hydraulic ram 340 that includes an outer cylinder 342 and an inner cylinder 344. The hydraulic ram 340 is connected to the hydraulic pump system 346 of the hauling vehicle 10. A control mechanism 350 controls the fluid pressure in the two hydraulic rams 340. When the fluid pressure in the hydraulic rams 340 is increased, the inner cylinder 344 is forced out away from the outer cylinder 342. When the fluid pressure is decreased, the inner cylinder 344 returns within the outer cylinder 342. The outer cylinder 342 is connected to a pivot 356 on the hauling vehicle 10, while the inner cylinder 344 is connected to a pivot 358 on an extension arm 360. The extension plate 360 is connected to the vehicle end 26 of the receiving member 22. The vehicle end 26 of the receiving member 22 is also connected to a connector 34 proximate the receptacle 16. The vehicle end 26 is connected to the base member 30 of the loading end 24 of the receiving member 22. In a preferred embodiment, the base member 30 is configured so that it is positioned close to the ground surface 25, parallel to the ground surface 25. The vehicle end 26 forms an angle 29 with the base member 30 in the range of about 90 degrees to about 180 degrees. In a preferred embodiment, the angle formed is in the range of about 120 degrees to about 165 degrees. In this embodiment, when the operation means 38 is activated to load material deposited on the loading end 24, the inner cylinder 344 of the hydraulic ram 340 extends to force the extension plate 360 downwards thereby rotating the receiving member 22 upwards towards the transfer position in which the base member 30 is raised and elevated away from the ground surface 25, such that material deposited on the base member 30 then falls with the force of gravity towards the vehicle end 26 and then into the receptacle 16 of the hauling vehicle 10. FIG. 9 depicts the embodiment of FIG. 8 with the inner cylinder 344 of hydraulic ram 340 extended, and the base member 30 rotated upwards in the transfer position. The receiving member 22 can also be rotated further upwards into a storage position (not depicted), for transporting the hauling vehicle 10 and apparatus 20.

It is contemplated that the apparatus in the various embodiments described can be manufactured with the hauling vehicle in the manufacturing process for the hauling vehicle, or can be manufactured as a separate unit for attachment to one or a wide variety of hauling vehicles.

Particular embodiments have been described above that fall within the scope of the invention as set forth in the claims. These embodiments are not intended to limit the scope of the invention to the specific forms disclosed. The invention is intended to cover all modifications and alternative forms falling within the spirit and scope of the invention.

I claim:

1. An apparatus for loading material into a hauling vehicle, said hauling vehicle including a storage area for holding said material, comprising:
a receiving member for receiving material thereon and transferring said material toward said storage area, said receiving member having a vehicle end positioned toward said vehicle and a loading end positioned away from said vehicle, said receiving member being movable between a deployed position extending away from said vehicle and positioned for the placement of material on said loading end and a transfer position in which said receiving member is positioned to transfer material placed on the loading end toward said hauling vehicle;
a connector for rotatably connecting said vehicle end of said receiving member to said vehicle proximate said storage area; and
operation means for moving said receiving member between said deployed position and said transfer position.

2. The apparatus of claim 1 wherein said loading end includes a base member, the base member positioned while the receiving member is in deployed position at a lower elevation above the ground surface than the storage area of said hauling vehicle, the base member being proximate the ground surface where said material is located for loading, the base member also being connected to said vehicle end, the vehicle end forming an angle in the range of about 120 degrees to about 160 degrees with the base member.

3. The apparatus of claim 2 wherein the angle formed by said base member and said vehicle end is in the range of about 145 degrees to about 180 degrees.

4. The apparatus of claim 2 wherein the angle formed by said base member and said vehicle end is in the range of about 90 degrees to about 145 degrees.

5. The apparatus of claim 2 wherein, following the loading of material on said base member in the deployed position, said operation means is activated to lift said base member and the material thereon into said transfer position, wherein the base member is elevated to cause the material on said base member to slide with the force of gravity down the base member and thenceforth down the vehicle end and into said storage area.

6. The apparatus of claim 2 wherein said receiving member includes a guide member located at said vehicle end positioned proximate said storage area and oriented to direct material from said vehicle end into said storage area, when said receiving member is positioned in the transfer position.

7. The apparatus of claim 2 wherein said base member includes a frame and canvas material disposed over said frame.

8. The apparatus of claim 2 wherein said base member includes a flat metal sheet, formed in the shape of a tray, for receipt of said material thereon.

9. The apparatus of claim 1 wherein said receiving member has opposite sides extending above and away from said vehicle end, and wherein said receiving member has side walls attached to extend upwardly from said receiving member proximate said opposite sides.

10. The apparatus of claim 1 wherein said operation means includes a reel attached to said hauling vehicle and a cable attached to said receiving member, said reel being configured to be operable to wind and unwind said cable to move said receiving member between said deployed position and said transfer position.

11. The apparatus of claim 1, wherein said operation means includes a worm gear mechanism.

12. The apparatus of claim 1, wherein said operation means includes a hydraulic ram mechanism connected to a hydraulic system of the hauling vehicle.

13. The apparatus of claim 1, wherein said connector includes a hinge attached to said vehicle end of said receiving member, and to a rear support member of said hauling vehicle.

14. The apparatus of claim 1, wherein said connector includes a pivot mechanism.
